(19) United States
(12) Patent Application Publication
(10) Pub. No.: US 2005/0110722 A1
(43) Pub. Date: May 26, 2005

(54) Drive device and drive method of a self light emitting display panel

(75) Inventor: Akinori Hayafuji, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 10/976,825

(22) Filed: Nov. 1, 2004

(30) Foreign Application Priority Data
Nov. 25, 2003 (JP) 2003-394356

(51) Int. Cl. G09G 3/30

(52) U.S. Cl. 345/76

(57) ABSTRACT

In a drive device of a passive drive type display panel in which a drive current is selectively supplied from a current source CI to the light emitting elements E corresponding to a scan line that is a scan object via the drive line, the current source CI comprises precharge current supply means for supplying a constant current for charging parasitic capacitances of light emitting elements E to light emitting elements E and drive current supply means for supplying a constant current for driving and allowing light emitting elements E to emit light to light emitting elements E, and light emitting elements E in each of which the voltage between terminals thereof is increased to a light emission threshold value Vth by the constant current supplied from the precharge current supply means are driven to emit light by the constant current supplied from the drive current supply means.

### BACKGROUND OF THE INVENTION

1. Field of the Invention

The present invention relates to a drive device and a drive method of a self light emitting display panel in which self light emitting elements such as organic EL (electroluminescent) elements and the like are employed.

2. Description of the Related Art

A display employing a display panel constructed by arranging light emitting elements in a matrix pattern has been developed widely. As the light emitting element employed in such a display panel, for example, an organic EL (electroluminescent) element in which an organic material is employed in a light emitting layer has attracted attention.

As the display panel employing such organic EL elements, there is a passive drive type display panel in which a plurality of anode lines and cathode lines are arranged in a matrix pattern and in which the organic EL elements are arranged and connected at the crossing positions thereof. With respect to this passive drive type display panel, there is no need to provide an active element for each pixel, and producing it at a low price is easy, whereby it has already been put into practical use in products partly.

The organic EL element can be electrically shown by an equivalent circuit as shown in FIG. 1. That is, the organic EL element can be replaced by a structure composed of a light emitting component E constituted by a diode component and a parasitic capacitance component Cp which is connected in parallel to this light emitting component, and the organic EL element has been considered as a capacitive light emitting element.

When a light emission control voltage is applied to this organic EL element, at first, electrical charges corresponding to the electric capacity of this element flow into the electrode as displacement current and are accumulated. It can be considered that when the light emission control voltage then exceeds a predetermined voltage (light emission threshold voltage=Vth) peculiar to this element, current begins to flow from the electrode (anode side of the diode element E) to an organic layer constituting the light emitting layer so that the element emits light at an intensity proportional to this current.

FIG. 2 shows light emission static characteristics of such an organic EL element. According to these, the organic EL element emits light at an intensity (L) approximately proportional to a drive current (I) as shown in FIG. 2A and emits light while the current (I) flows drastically when the drive voltage (V) is the light emission threshold voltage (Vth) or higher as shown in FIG. 2B. In other words, when the drive voltage is the light emission threshold voltage (Vth) or lower, current rarely flows in the EL element, and the EL element does not emit light. Therefore, the EL element has an intensity characteristic that in a light emittable region in which the drive voltage is higher than the threshold voltage (Vth), the greater the value of the voltage (V) applied to the EL element, the higher the light emission intensity (L) thereof as shown by the solid line in FIG. 2C.

Meanwhile, in the passive drive type display panel, as a system to perform gradation display, conventionally there is time gradation control system. This time gradation control system is a system in which light emitting elements are driven by constant current so that the light emitting elements emit light and in which light emission time thereof is controlled so that gradation expression is performed. However, in this time gradation control system, there is a following problem caused by the above-mentioned capacitance that the organic EL element has. That is, in the passive drive, as described above, at first, electrical charges are accumulated as the displacement current in the parasitic capacitance of the light emitting element, and then light emission is started. Thus, when charge to the element (hereinafter referred to as precharge) is not performed, needed is time to boost the voltage between terminals of the light emitting element to the light emission threshold voltage, and light emission of the element is insufficient.

Therefore, in the time gradation control system, in the case where precharge is not performed, a problem occurs where control of the light emission time of the light emitting element cannot be performed correctly. However, as a method to solve such a problem, there is a method in which a constant voltage is supplied immediately before light emission start to the light emitting element so as to precharge the parasitic capacitance of the light emitting element (for convenience, referred to as a constant voltage precharge method).

FIG. 3 is an example of a circuit structure of a drive device of a passive drive type display panel employing the constant voltage precharge method. In FIG. 3, anode lines A₁ to Aₘ and cathode lines B₁ to Bₙ are arranged in a matrix pattern, and light emitting elements E_{1,1} to E_{m,n} that are organic EL elements are connected at respective crossing positions thereof. In this circuit structure, while the anode lines A and the cathode lines B are data lines and scan lines, respectively, the cathode lines B are selected and scanned sequentially at predetermined time intervals, and the anode lines are driven by constant current sources C₁ to Cm in synchronization with this scanning, whereby light emitting elements E at arbitrary crossing positions emit light. Constant current I is supplied from respective constant current sources C as drive current.

The circuit structure of FIG. 3 will be described further in detail. A cathode line scan circuit 1 is equipped with scan switches 5₁ to 5ₙ for sequentially scanning respective cathode lines B₁ to Bₙ, and a reverse bias voltage Vm is supplied to one ends of the respective scan switches 5 while other terminals are connected to ground respectively. An anode drive circuit 2 is equipped with constant current sources C₁ to Cₘ that are drive sources and drive switches 6₁ to 6ₘ for selecting the respective anode lines A₁ to Aₘ. Each drive switch 6 employs a three contact change-over switch, wherein first contact, second contact, and third contact are connected to a voltage source AVL (ground) employed in reset time or gradation control, a constant current source C, and a voltage source AVM for applying a precharge voltage, respectively. ON/OFF operations in the respective scan switches 5 and drive switches 6 are controlled by a light emission control circuit 4.

In such a circuit structure, as shown in FIG. 3, for example in the case where the light emitting elements E_{1,1}, and E_{3,1} are allowed to emit light, a switching operation is performed as follows. First, the scan switch 5₁ is switched to the ground potential side, and the cathode line B₁ is scanned. Meanwhile, the current sources C₁ and C₃ are connected to the anode lines A₁ and A₃ by means of the drive switches 6₁ and 6₃, respectively.

The reverse bias voltage Vm is applied to the cathode lines B₂ to Bₙ by means of the scan switches 5₂ to 5ₙ, and the drive switches 6₂ and 6₄ to 6ₘ are switched to the first contact to be connected to the voltage source AVL. That is, only E_{1,1} and E_{3,1} are biased in forward direction to emit light, and other light emitting elements are in a state in which they do not emit light due to no supply of constant current from the current source C by switching of the drive switches 6, or in a state in which current of reverse bias is supplied, or in a state in which positive charges are charged.

Further, in this circuit structure, after a line scan period is finished, until the time scanning proceeds to a next line scan, the precharge voltage is applied. When the light emitting elements connected to the cathode line B₁ are charged while this precharge voltage is applied, the cathode line B₁ is grounded by means of the scan switch 5₁ as shown in FIG. 4, and the cathode lines B₂ to Bₙ are connected to the reverse bias voltage Vₘ by means of the scan switches 5₂ to 5ₙ. All anode lines A₁ to Aₘ are connected to the voltage source AVM by means of the drive switches 6₁ to 6ₘ. At this time, since positive charges are charged from the voltage source AVM in the parasitic capacitances of the respective light emitting elements E, light emission of light emitting elements in the next scan is performed instantaneously. Thus, since light emission of all light emitting elements is performed quickly by employing this constant voltage precharge method, time gradation control can be performed correctly by controlling light emission time of respective light emitting elements by constant current drive.

In the case of the structure in which the voltage source AVM is not limited to a constant voltage and in which the applied voltage is changed for each anode line (drive line) in accordance with characteristics of respective elements (variable voltage precharge method), light emission time control of light emitting elements can be performed more correctly. Such a variable voltage or constant voltage precharge method is also disclosed for example in Japanese Patent Application Laid-Open No. 11-143429 (paragraphs 0034 to 0049 and FIGS. 1 to 5).

Meanwhile, in the circuit structure shown in FIGS. 3 and 4, the anode drive circuit 2 is equipped with the constant current sources C that are drive sources for the respective anode lines that are drive lines and the drive switches 6 each of which has a three contact change-over switch as described above. Although not shown, in an actual circuit structure, other than these, a circuit generating the voltage of AVM from AVH that is the voltage source of the constant current sources C and the like is needed. Therefore, an actual circuit structure of the anode drive circuit 2 is more complex, and other problems have occurred where the number of gates of the IC and the circuit size are large.

Meanwhile, as a system to display gradation on a passive drive type display panel, other than the time gradation control system, there is a system in which the amount of current supplied to light emitting elements is controlled to perform gradation expression (for convenience, referred to as a current gradation control system). As a circuit structure therefor, for example, there are a structure (not shown) in which a plurality of constant current sources are provided for each drive line so that the values of current supplied to the drive lines are changed by selectively performing ON/OFF operation for respective current sources, a structure (not shown) in which a D/A converter is provided for each drive line so as to change current value, and the like. However, in a circuit structure of this current gradation control system also, it is difficult to restrain variations in a plurality of current sources or D/A converters for each drive line, and the circuit scale is complex and large, whereby there are problems in terms of circuit size, power consumption, cost, and the like.

### SUMMARY OF THE INVENTION

The present invention has been developed as attention to the above-described technical problems has been paid, and it is an object of the present invention to provide a drive device and a drive method of a self light emitting display panel which can perform gradation expression correctly by efficiently performing precharge for light emitting elements while restraining an increase of the circuit scale to ensure the light emittable time of light emitting elements in a passive drive type display panel in which light emitting elements are arranged in a matrix pattern.

A drive device of a self light emitting display panel according to the present invention which has been developed to solve the problems is a drive device of a passive drive type display panel in which light emitting elements are arranged at respective intersecting positions of a plurality of drive lines and a plurality of scan lines and in which a drive current is selectively supplied from a current source to the light emitting elements corresponding to a scan line that is a scan object via the drive line, characterized in that the current source comprises precharge current supply means for supplying a constant current for charging parasitic capacitances of light emitting elements to light emitting elements and drive current supply means for supplying a constant current for driving and allowing light emitting elements to emit light to light emitting elements and that light emitting elements in each of which the voltage between terminals thereof is increased to a light emission threshold value by the constant current supplied from the precharge current supply means are driven to emit light by the constant current supplied from the drive current supply means.

A drive method of a self light emitting display panel according to the present invention which has been developed to solve the problems is a drive method of a passive drive type display panel in which light emitting elements are arranged at respective intersecting positions of a plurality of drive lines and a plurality of scan lines and in which a drive current is selectively supplied from a current source to the light emitting elements corresponding to a scan line that is a scan object via the drive line, characterized in that after a constant current is supplied to light emitting elements so that the voltage between terminals thereof is increased to a light emission threshold value by precharge current supply means that the current source has, a constant current is supplied to light emitting elements so that the light emitting elements is driven to emit light by drive current supply means that the current source has.

### BRIEF DESCRIPTION OF THE DRAWINGS

FIG. 1 is an equivalent circuit diagram showing an electrical structure of an organic EL element;

FIG. 2 is characteristic views explaining electrical, static characteristics of an organic EL element;

FIG. 3 is a connection diagram showing an example of a drive device of a conventional passive drive type display panel;

FIG. 4 is a connection diagram showing an operational state of the drive device of the passive drive type display panel shown in FIG. 3;

FIG. 5 is a connection diagram showing a passive drive type display panel according to one embodiment of the present invention;

FIG. 6 is a connection diagram showing one example of a circuit structure of a constant current source with which the drive device of the passive drive type display panel of FIG. 5 is equipped;

FIG. 7 is a timing diagram showing one example of operational timing of the drive device of the passive drive type display panel of FIG. 5; and

FIG. 8 is a timing diagram showing one example of operational timing of the drive device of the passive drive type display panel of FIG. 5.

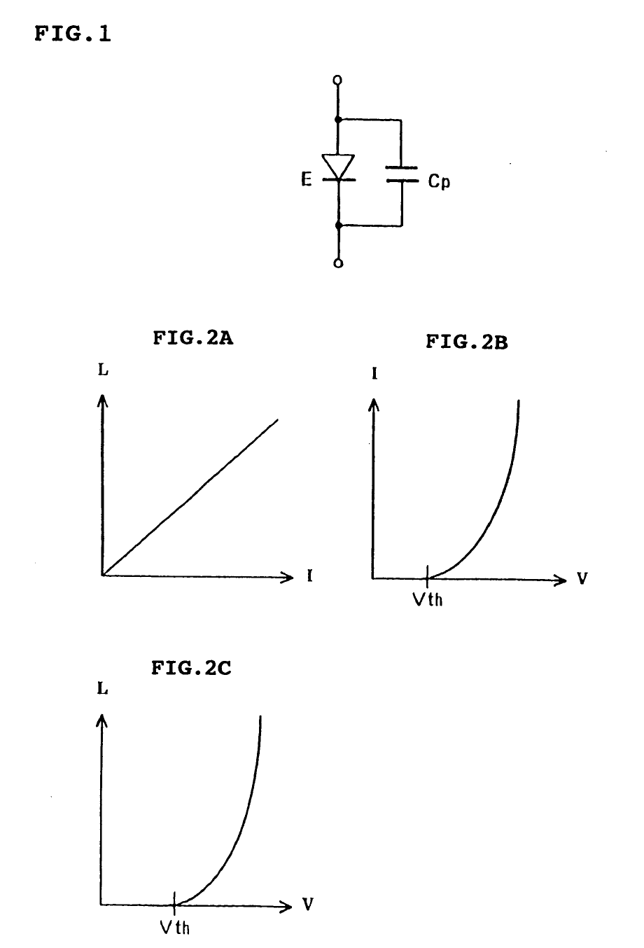

### DESCRIPTION OF THE PREFERRED EMBODIMENT

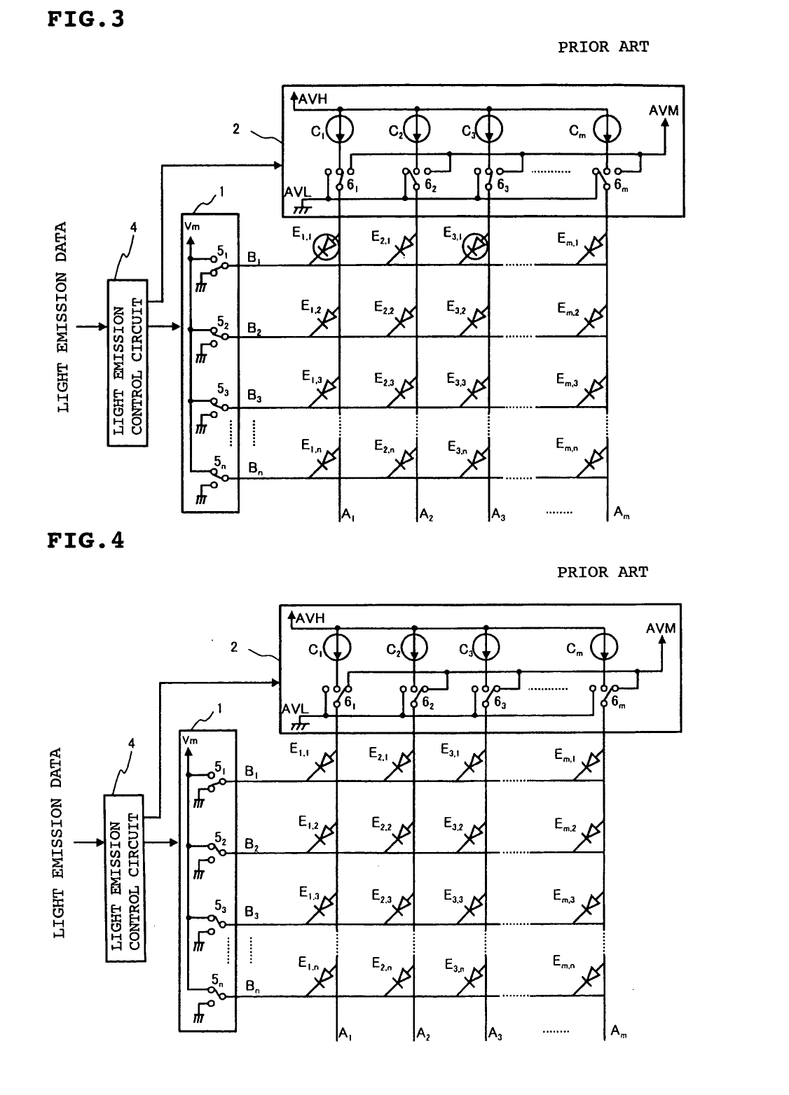

A drive device and a drive method of a self light emitting display panel according to the present invention will be described below with reference to an embodiment shown in the drawings. In the following explanation, portions corresponding to the respective portions shown in FIGS. 3 and 4 already described are designated by the same reference characters, and therefore explanation for respective functions and operations will be appropriately omitted.

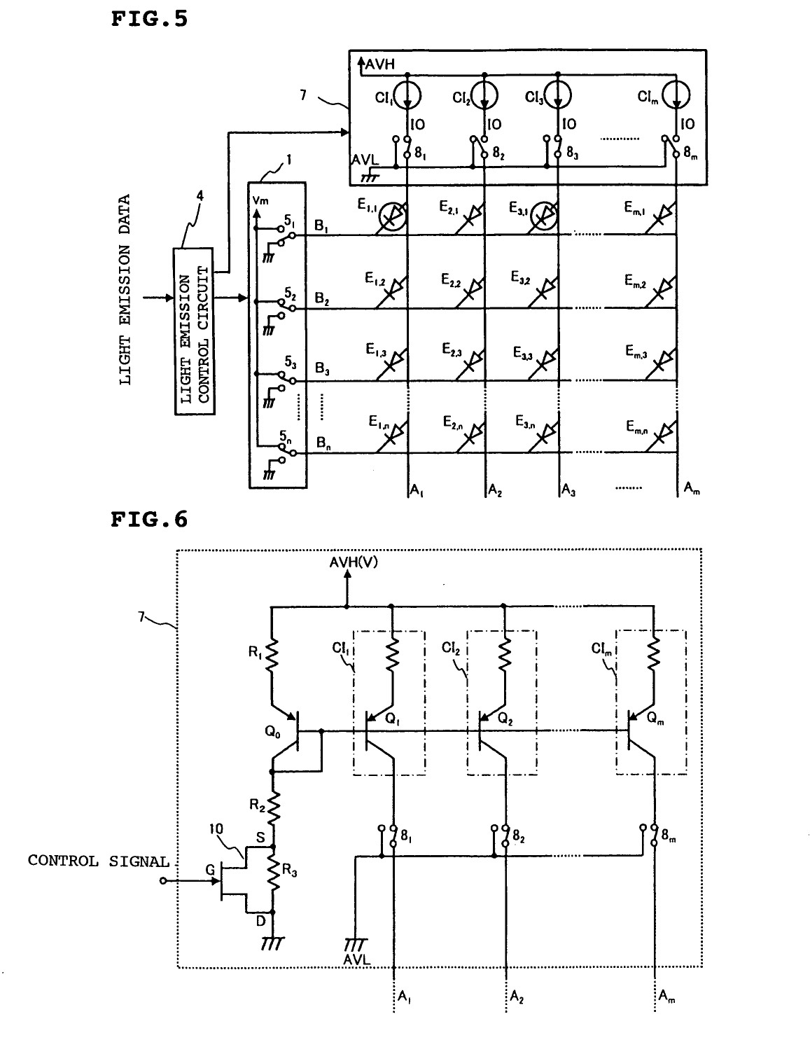

FIG. 5 shows one embodiment of a passive drive type display panel and its drive device as one example of a drive device of a self light emitting display panel according to the present invention. In the present embodiment, anode lines are drive lines, and cathode lines are scan lines. The circuit structure shown in FIG. 5 differs from the form of FIGS. 3 and 4 in terms of realization by an anode drive circuit 7 for drive control for light emitting elements E from anode lines, instead of the anode drive circuit 2 in the drive device of the passive drive type display panel shown in FIGS. 3 and 4. This anode drive circuit 7 is provided with constant current sources CI₁ to CIₘ that are drive sources for light emitting elements and drive switches 8₁ to 8ₘ which select respective anode lines A₁ to Aₘ. Each drive switch 8 employs a two contact change-over switch, wherein first contact and second contact are connected to a voltage source AVL (ground) employed at reset time or gradation control and the constant current source CI, respectively. ON/OFF operations in the respective scan switches 5 and drive switches 8 are controlled by a light emission control circuit 4.

In the drive device and drive method according to the present invention, for precharging light emitting elements, a constant voltage is not applied to light emitting elements, but a constant current is supplied thereto. The respective constant current sources CI are constructed so as to output a constant current for precharging light emitting elements during a precharge period (precharge current supply means) and output a constant current for light emission drive to light emitting elements during a light emission period (drive current supply means). The anode drive circuit 7 including this constant current sources CI will be described further with reference to FIG. 6.

In the circuit structure of the anode drive circuit 7 shown in FIG. 6, a control side transistor Q₀ is arranged, and the base of this transistor Q₀ and the bases of transistors Q₁ to Qₘ in the respective constant current sources CI are connected. The emitter side of the transistor Q₀ is connected to the voltage source AVH via a resistor R₁, and the collector side thereof is connected to the base directly and to ground via resistors R₂, R₃ which are connected in series to each other.

Further, source S and drain D of an FET 10 that is a control transistor are connected to both ends of the resistor R₃, respectively, so as to perform ON/OFF control of current flowing in the resistor R₃. That is, a control signal (voltage control) from the light emission control circuit 4 is inputted to gate G of this FET 10, and ON/OFF of gate is switched between the precharge period and the constant current drive period (light emission period) of the light emitting elements E by this control signal.

Specifically, current does not flow in the resistor R₃ but bypasses during the precharge period of the light emitting elements E, and current flows in the resistor R₃ during the constant current drive period of the light emitting elements E. That is, the collector resistance value of transistor Q₀ changes by the ON/OFF control operation of the FET 10, and in response to this, the collector current (absorption current) of the transistor Q₀ is determined. Therefore, base-emitter voltages of the respective transistors Q₁ to Qₘ change in response to this absorption current change, and thus the value of the current supplied to the respective anode lines A₁ to Aₘ (collector current) is determined. In the present embodiment, the respective resistance values of the resistor R₁ to R₃ are set so that the value of the current supplied to the respective anode lines A at the time of precharge for the parasitic capacities of the light emitting elements is approximately two times the value of the current supplied at the constant current drive time of the light emitting elements.

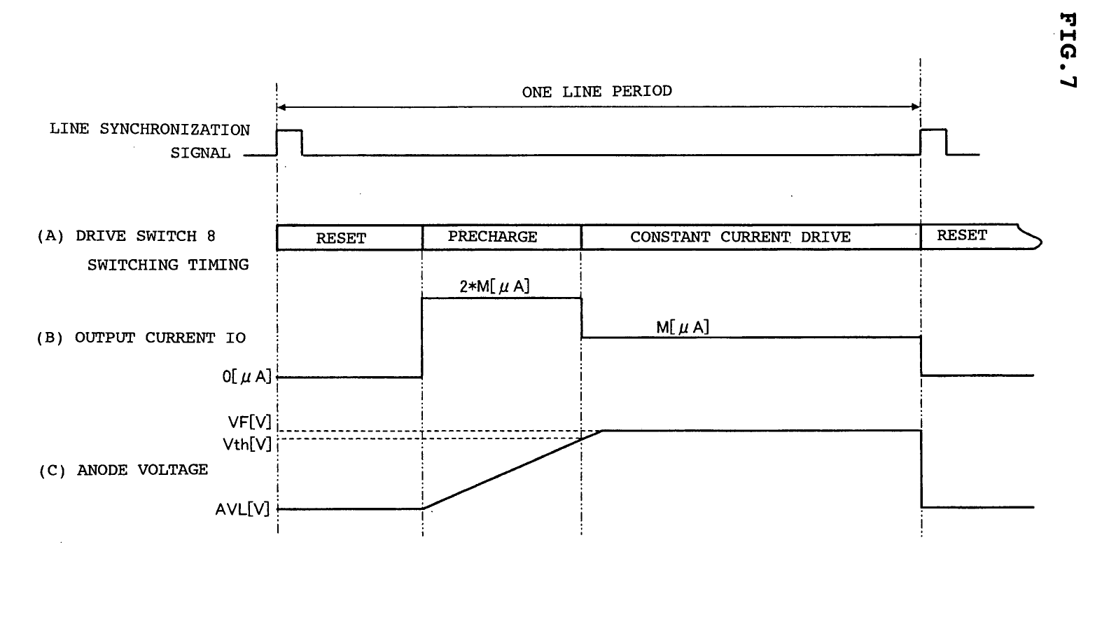

Next, operations of the drive device of the passive drive type display panel constructed in such a manner will be described. FIG. 7 is a view showing timing of a light emission drive operation during the scan period of one line. As shown in (a) of FIG. 7, during one line scan period, for the light emitting element E, reset, precharge, and constant current drive (light emission) are performed respectively by switching operations of the drive switches 8. Although the precharge and the constant current drive are performed after the reset in (a) of FIG. 7, the reset operation may be performed after the constant current drive.

As shown in (b) of FIG. 7, with respect to output current IO from the constant current source CI, where the constant current value of the constant current drive time is M (μA), the constant current value of the precharge period is 2M (μA), that is, the current value of two times the current value of the constant current drive time. Thus, by allowing the constant current value of the precharge period to be two time the constant current value of the constant current drive time, the voltage of the light emitting element changes as shown in (c) of FIG. 7. That is, although the voltage of the light emitting element is AVL (=0 volts) at the reset time, since current of two times the current of the constant current drive time is supplied to the element during the precharge period, the voltage of the element rapidly increases linearly. Then, when the voltage of the light emitting element E reaches the light emission threshold value Vth, the precharge period shifts to the constant current drive period, and the value of the output current IO of the current source CI is switched to the constant current value of the light emission time (the voltage is constant, VF).

Although not shown, it is desired that electrical potential measuring means for measuring the electrical potential of the anode line that is the drive line is provided and that the precharge period is finished to shift to the constant current drive when the electrical potential that this electrical potential measuring means has measured reaches the light emission threshold voltage Vth of the light emission element E. By constructing in such a way, the precharge period can be determined in response to characteristics of the element, and light emission efficiency of the light emitting element E can be improved further.

In the case where the precharge period is not provided and where the reset shifts to the constant current drive, needed is time to allow the voltage between terminals of the light emitting element to reach the light emission threshold value Vth. However, by providing the precharge period as described above, and during this period by supplying the constant current of two times the current of the constant current drive time to the light emitting element, the voltage of the light emitting element can be rapidly increased to the light emission threshold voltage Vth, and the light emitting element E can be allowed to emit light instantly during the constant current drive time.

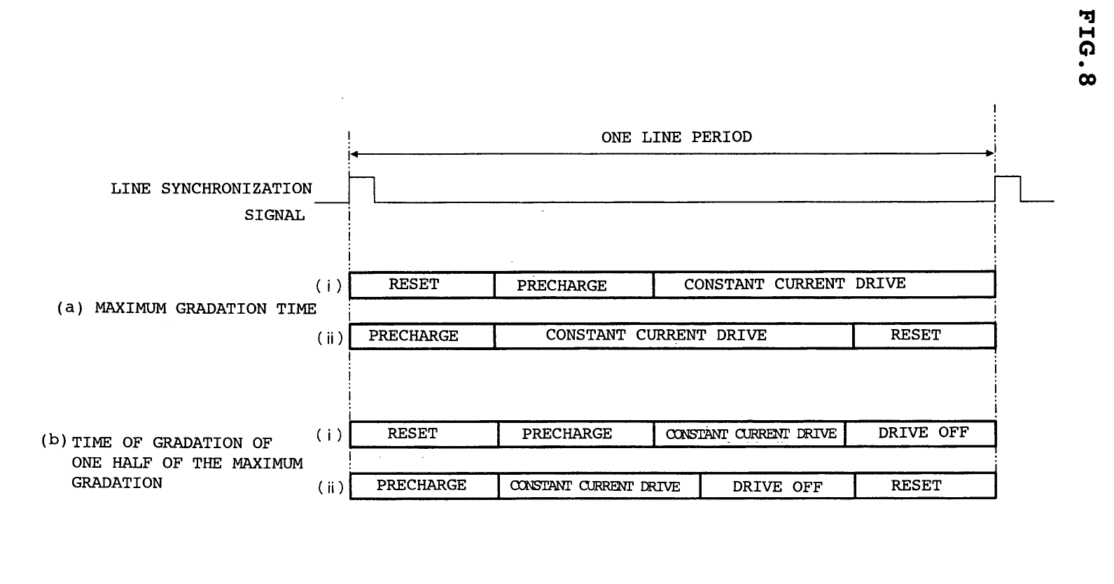

In the drive device of such a circuit structure, since the light emission drive for the light emitting element E is performed by the constant current drive, the gradation expression therefor is performed by the time gradation method. FIG. 8 shows drive timing of gradation display during one line period. Where timings shown in FIG. 8A are drive timings of maximum gradation times, in the case where gradation of one half thereof is expressed, the constant current drive period of the element light emission time is allowed to be one half of the constant current drive period of FIG. 8A in a time domain as shown in FIG. 8B. In this case, during one line period, in a time period from stop of the constant current drive to a next reset period (drive off), control is performed so that current is not supplied to the light emitting element E. That is, the anode line A is connected to AVL by means of the drive switch 8. As described above, the parasitic capacitances of the respective light emitting elements E are charged by precharge current so that the voltages of the respective light emitting elements E are increased to the light emission threshold value Vth by precharge current. Thus, the elements can be allowed to emit light instantly during the constant current drive period, light emission efficiency is improved, and gradation control can be performed correctly.

As shown in FIG. 5, in the case where the light emitting elements E_{1,1} and E_{3,1} are allowed to emit light, a switching operation is performed as follows. First, the scan switch 51 is switched to the ground potential side, and the cathode line B₁ is scanned. Meanwhile, the anode lines A₁ and A₃ are tentatively connected to AVL by the drive switches 8₁ and 8₃, and after the light emitting elements E_{1,1} and E_{3,1} are reset, the anode lines A₁ and A₃ are connected to the constant current sources CI₁ and CI₃, respectively.

Here, the constant current having the current value of two time the current value of the constant current drive time is supplied to the light emitting elements E_{1,1}, and E_{3,1} by the constant current sources CI₁ and CI₃ so that precharge is performed. The constant current supply during the precharge period by the constant current sources CI₁, and CI₃ finishes when the voltages of the light emitting elements E_{1,1}, and E_{3,1} reach the light emission threshold value Vth, and thereafter shifts to the constant current drive, where he drive current is supplied from the constant current sources CI₁ and CI₃ to the light emitting elements so that the elements emit light.

Meanwhile, a reverse bias voltage is applied to the cathode lines B₂ to Bₙ by means of the scan switches 52 to 5ₙ, and the drive switches 8₂ and 8₄ to 8ₘ are switched to the first contacts to be connected to AVL. That is, only E_{1,1} and E_{3,1} are biased in a forward direction to emit light, and other light emitting elements are in a state in which the elements do not emit light since the constant current is not supplied from the constant current sources IC by switching of the drive switches 8, or in a state in which current of reverse bias is supplied, or in a state in which positive charges are charged.

With the present embodiment described above, by providing the precharge period during one line scan period, and during this period by supplying, to the light emitting elements, the constant current whose current value is greater than the current of the constant current drive time, the light emitting elements can be precharged rapidly, whereby the elements can be allowed to emit light instantly, and light emittable time of the light emitting element can be ensured. Further, by controlling the light emission time of each light emitting element by the constant current drive, time gradation control can be performed correctly.

Moreover, the circuit structure of the anode drive circuit 7 and the constant current sources CI shown in FIGS. 5 and 6 can reduce the number of switches, the number of voltage sources, and the like, compared to those in the structure of the anode drive circuit 2 shown in FIGS. 3 and 4, and circuit area increase can be restrained. The circuit structure according to the present invention can be simplified drastically compared to the circuit structure of a current gradation method in which a plurality of constant current sources or a D/A converter are needed for each drive line. That is, in the drive device and drive method according to the present invention, the number of gates of the IC can be reduced further compared to that in the circuit structure by time gradation method or current gradation method in which conventional constant voltage precharge is employed, and increase of the circuit area can be restrained. Thus, power consumption and cost can be reduced further.

Although the constant current of the precharge time to the light emitting elements is set to two times the constant current of the constant current drive time in the above-described embodiment, the constant current is not limited to this multiplying factor. For example, in order to cope with display panels with various resolutions and various light emission efficiencies, this multiplying factor may be set at a larger multiplying factor so that the parasitic capacitance of the light emitting element can be precharged more rapidly. The circuit structure shown in FIG. 6 is one example, and the circuit structure may take any structures as far as such a structure is one in which the drive current is outputted at the constant current drive time and in which the constant current with a value greater than that of the constant current drive time is outputted during the precharge period that is before the constant current drive. Although the present embodiment is constructed in such a manner that the anode lines are drive lines and the cathode lines are scan lines, in a drive device and a drive method according to the present invention, cathode lines may be drive lines and anode lines may be scan lines.

1. A drive device of a passive drive type display panel in which light emitting elements are arranged at respective intersecting positions of a plurality of drive lines and a plurality of scan lines and in which a drive current is selectively supplied from a current source to the light emitting elements corresponding to a scan line that is a scan object via the drive line, wherein the drive device of a self light emitting display panel is characterized in that the current source comprises precharge current supply means for supplying a constant current for charging parasitic capacitances of light emitting elements to light emitting elements and drive current supply means for supplying a constant current for driving and allowing light emitting elements to emit light to light emitting elements and that light emitting elements in each of which the voltage between terminals thereof is increased to a light emission threshold value by the constant current supplied from the precharge current supply means are driven to emit light by the constant current supplied from the drive current supply means.

2. The drive device of a self light emitting display panel according to claim 1, characterized in that the value of the constant current supplied from the precharge current supply means is set at a value greater than the value of the constant current supplied from the drive current supply means.

3. The drive device of a self light emitting display panel according to claim 1, characterized in that time gradation control is performed during an operation period of the drive current supply means to perform gradation display.

4. The drive device of a self light emitting display panel according to claim 2, characterized in that time gradation control is performed during an operation period of the drive current supply means to perform gradation display.

5. The drive device of a self light emitting display panel according to any one of claims 1 to 4, characterized in that a precharge period during which the constant current is supplied to light emitting elements by the precharge current supply means is a period from the time that a supply of the constant current to light emitting elements is started to the time the light emitting elements emit light.

6. The drive device of a self light emitting display panel according to claim 5 characterized by further comprising electrical potential measuring means for measuring the electrical potential of the drive line to which the constant current is supplied by the precharge current supply means so that the precharge period is determined by the electrical potential that the electrical potential measuring means has measured.

7. The drive device of a self light emitting display panel according to any one of claims 1 to 4, characterized in that the light emitting element is an organic EL element.

8. The drive device of a self light emitting display panel according to claim 5, characterized in that the light emitting element is an organic EL element.

9. The drive device of a self light emitting display panel according to claim 6, characterized in that the light emitting element is an organic EL element.

10. A drive method of a passive drive type display panel in which light emitting elements are arranged at respective intersecting positions of a plurality of drive lines and a plurality of scan lines and in which a drive current is selectively supplied from a current source to the light emitting elements corresponding to a scan line that is a scan object via the drive line, wherein a drive method of a self light emitting display panel is characterized in that after a constant current is supplied to light emitting elements so that the voltage between terminals thereof is increased to a light emission threshold value by precharge current supply means that the current source has, a constant current is supplied to light emitting elements so that the light emitting elements is driven to emit light by drive current supply means that the current source has.

11. The drive method of a self light emitting display panel according to claim 10, characterized in that the value of the constant current supplied from the precharge current supply means is set at a value greater than the value of the constant current supplied from the drive current supply means.

12. The drive method of a self light emitting display panel according to claim 10, characterized in that time gradation control is performed during an operation period of the drive current supply means to perform gradation display.

13. The drive method of a self light emitting display panel according to claim 11, characterized in that time gradation control is performed during an operation period of the drive current supply means to perform gradation display.

14. The drive method of a self light emitting display panel according to any one of claims 10 to 13, characterized in that a precharge period during which the constant current is supplied to light emitting elements by the precharge current supply means is a period from the time that a supply of the constant current to light emitting elements is started to the time the light emitting elements emit light.

15. The drive method of a self light emitting display panel according to claim 14, characterized in that the electrical potential of the drive line to which the constant current is supplied by the precharge current supply means is measured by electrical potential measuring means to determine the precharge period by the electrical potential that the electrical potential measuring means has measured.
